(19) United States
(12) Patent Application Publication
(10) Pub. No.: US 2014/0245153 A1
(43) Pub. Date: Aug. 28, 2014

(54) IMAGE PROCESSING APPARATUS, COMPUTER-READABLE MEDIUM STORING AN IMAGE PROCESSING PROGRAM, AND IMAGE PROCESSING METHOD

(71) Applicant: NK WORKS CO., LTD., Wakayama-shi (JP)

(72) Inventors: Tomoo Nakano, Wakayama-shi (JP); Koji Kita, Wakayama-shi (JP)

(73) Assignee: NK WORKS CO., LTD., Wakayama-shi (JP)

(21) Appl. No.: 14/192,023

(22) Filed: Feb. 27, 2014

(30) Foreign Application Priority Data
Feb. 28, 2013 (JP) 2013-039365

(51) Int. Cl. G06F 3/0484

(52) U.S. Cl. CPC G06F 3/0484
USPC 715/723

(57) ABSTRACT

An image processing apparatus is provided. The image processing apparatus includes a selection unit, a registration unit, a re-selection unit, and a frame processing unit. The selection unit allows a user to select any segment on a timeline of a video. The registration unit receives a registration instruction from the user and executes registration processing for registering the segment that is currently selected on the timeline. The re-selection unit allows the user to select the registered segment. The frame processing unit executes image processing, export processing, or print processing on a frame group belonging to the segment that is currently selected on the timeline.

### FIELD OF INVENTION

The present invention relates to an image processing apparatus and a computer-readable medium storing an image processing program.

### BACKGROUND

A video includes multiple frames arranged in a timeline. When a user attempts to perform image processing, export processing, or print processing on a video, it is often desired that these processes are executed only on frame groups corresponding to partial segments on the timeline. Accordingly, a design by which the user can select any segment on the timeline as the target of these processes is desired. In view of this, JP 2007-221301A discloses a print apparatus that allows the user to select any segment on the timeline of the video and executes print processing on the frame group corresponding to that segment. Before the print processing, the print apparatus also executes image processing for automatically adjusting image quality for the same frame group.

Incidentally, it is often desired that image processing, export processing, or print processing is executed repeatedly on a frame group in the same segment. Examples of this include the case where multiple types of image processing are executed in combination (removing noise and then changing brightness, etc.) and the case where some type of image processing is executed, and then the result of that processing is subsequently subjected to export processing, print processing, or the like. In these cases, no problem will occur when the processes are automatically executed successively. However, even in the case of processing for the same segment, there are cases where the user needs to re-select the segment that is to be subjected to the processing. One example is the case where the user selects a segment and executes some type of processing, then selects another segment and executes some type of processing, and thereafter furthermore decides to execute additional processing on the first segment. Due to the other segment having been selected, the selection of the first segment has been canceled, and therefore an operation of re-selecting the first segment is needed.

Also, if the user is forced to perform an operation similar to the first selection when re-selecting a specific segment, it cannot be said that user-friendliness is high. This is because the user needs to remember which frames were selected, and in the case of selecting a large number of frames, the number of operations may possibly increase.

### SUMMARY of INVENTION

It is an object of the present invention to provide an image processing apparatus and a computer-readable medium storing an image processing program that facilitate the re-selection of a segment on the timeline of a video.

An image processing apparatus according to a first aspect includes a selection unit, a registration unit, a re-selection unit, and a frame processing unit. The selection unit allows a user to select any segment on a timeline of a video. The registration unit receives a registration instruction from the user and executes registration processing for registering the segment that is currently selected on the timeline. The re-selection unit allows the user to select the registered segment. The frame processing unit executes image processing, export processing, or print processing on a frame group belonging to the segment that is currently selected on the timeline.

Here, the user can select any segment on the timeline of the video as the target of image processing, export processing, or print processing (referred to below as “image processing or the like” where appropriate). Also, the segment that is currently selected on the timeline is not only subjected to image processing or the like, but it is also registered upon the reception of the instruction from the user. Also, the segment registered in this way is thereafter a unit of segment selection performed by the user. Thus, the user can register segments that are very likely to be re-selected in advance. As a result, it is not necessary for the user to remember which frames were selected, and even if many frames are selected, the number of operations will not increase excessively. Accordingly, it is easy to re-select a segment on the timeline of the video.

Note that here, it does not matter whether the user selects a segment that is to be the target of registration first or inputs the registration instruction first. For example, a segment that has been selected by the user may be registered at the point in time when the registration instruction is input, and a segment that the user selects in a predetermined period after the registration instruction has been input may be registered. In the case of the latter example, an operation for determining the timing of the end of the predetermined period may be received from the user.

An image processing apparatus according to a second aspect is the image processing apparatus according to the first aspect, where the re-selection unit allows the user to select any segment from among options including multiple segments that have been registered using registration processing that was executed at different times.

Here, the user can register multiple re-selectable segments and can re-select any segment among options including the multiple segments. Accordingly, the user can easily re-select various segments by registering the various segments in advance.

An image processing apparatus according to a third aspect is the image processing apparatus according to the first aspect or the second aspect, further including an edit unit. The edit unit receives, from the user, an instruction to join together multiple segments registered using registration processing performed at different times and executes joining processing for registering a segment obtained by joining together the multiple segments.

Here, if multiple segments have been registered, the user can join them together. Accordingly, the user can define the re-selectable segments in a more flexible manner.

An image processing apparatus according to a fourth aspect is the image processing apparatus according to the first aspect or the second aspect, further including an edit unit and a display control unit. The edit unit allows the user to input attribute information corresponding to a segment that has been registered or is being registered using the registration processing, and stores the attribute information in association with the segment. The attribute information that has been stored in association with the segment is displayed in association with the segment by the display control unit such that the user can reference the attribute information when selecting the registered segment.

Here, the user can set the attribute information for a segment that has been registered or that is being registered, and that attribute information is presented to the user when re-selecting that segment. Accordingly, while referencing the attribute information set by the user, the user can easily decide whether or not to re-select the registered segment.

An image processing apparatus according to a fifth aspect is the image processing apparatus according to the fourth aspect, where the edit unit allows the user to input the attribute information in a free description format.

Here, the user can describe the above-mentioned attribute information using a free-description format. Accordingly, the user can freely set a description by which it is easy for the user to later remember what kind of one a segment that has been registered or is being registered is.

A computer-readable medium according to a sixth aspect stores an image processing program. The image processing program causes a computer to execute a step of allowing a user to select any segment on a timeline of a video, a step of receiving a registration instruction from the user and executing registration processing for registering the segment that is currently selected on the timeline, a step of allowing the user to select the registered segment, and a step of executing image processing, export processing, or print processing on a frame group belonging to the segment that is currently selected on the timeline. Here, an effect similar to that of the first aspect can be demonstrated.

### ADVANTAGEOUS EFFECTS OF INVENTION

According to the present invention, the user can select any segment on the timeline of the video as the target of image processing, export processing, or print processing. Also, the segment that is currently selected on the timeline is not only the target of image processing and the like, but it is also registered upon the reception of the instruction from the user. Also, the segment registered in this way is thereafter a unit of segment selection performed by the user. Thus, the user can register a segment that is very likely to be re-selected, in advance. As a result, it is not necessary for the user to remember which frames were selected, and even if many frames are selected, the number of operations will not increase excessively. Accordingly, it is easy to re-select a segment on the timeline of the video.

### BRIEF DESCRIPTION OF DRAWINGS

FIG. 1 is a block diagram of an image processing apparatus according to an embodiment of the present invention;

FIG. 2 is a diagram of a basic screen before image data is imported;

FIG. 3 is a diagram of a basic screen after image data is imported;

FIG. 4 is a diagram showing the data structure of a segment database;

FIG. 5 is a diagram of a segment selection pull-down menu before a comment is set;

FIG. 6 is a diagram of an edit window;

FIG. 7 is another diagram of an edit window;

FIG. 8 is yet another diagram of an edit window;

FIG. 9 is a diagram of a segment selection pull-down menu after some comments have been set; and

FIG. 10 is a diagram showing a still image group belonging to one timeline.

### DETAILED DESCRIPTION OF THE PREFERRED EMBODIMENTS

Hereinafter, an image processing apparatus and a computer-readable medium storing an image processing program according to an embodiment of the present invention will be described with reference to the drawings.

1. Overview of Image Processing Apparatus

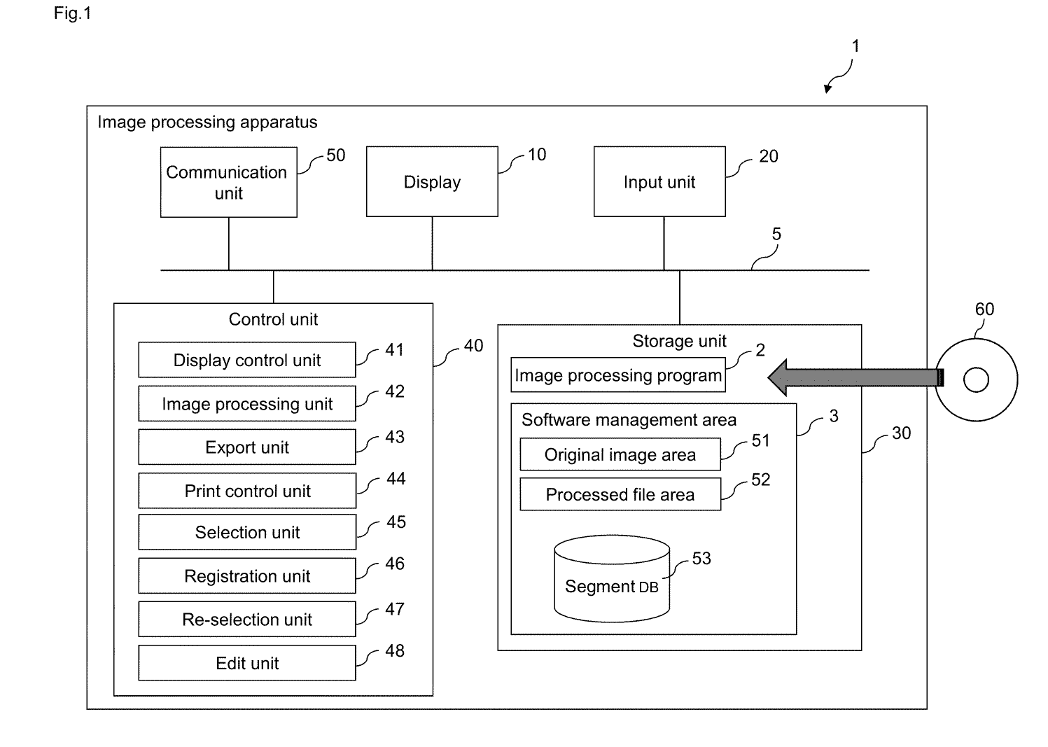

An image processing apparatus 1 shown in FIG. 1 is one embodiment of an image processing apparatus according to the present invention. The image processing apparatus 1 is a general-purpose personal computer. An image processing program 2 that is one embodiment of an image processing program according to the present invention is provided and installed in the image processing apparatus 1 via, for example, a computer-readable recording medium 60 such as a CD-ROM, a DVD-ROM and an USB memory that stores the image processing program 2. The image processing program 2 is application software for supporting image processing performed on moving images and still images. The image processing program 2 causes the image processing apparatus 1 to execute steps included in operations that will be described later.

The image processing apparatus 1 has a display 10, an input unit 20, a storage unit 30, a control unit 40, and a communication unit 50. The display 10, the input unit 20, the storage unit 30, the control unit 40 and the communication unit 50 can appropriately communicate with each other due to being connected to each other via a bus line or cable 5, for example. In the present embodiment, the display 10 is configured by a liquid crystal display or the like and displays later-described screens and the like to a user. The input unit 20 is configured by a mouse and a keyboard, or the like and receives operations performed by the user on the image processing apparatus 1. The storage unit 30 is a non-volatile storage area configured by hard disk or the like. The control unit 40 is configured by a CPU, a ROM and a RAM, or the like. The communication unit 50 is configured by a LAN port and an USB port, or the like and is a communication interface that enables communication between external devices and the image processing apparatus 1 via LAN, Internet, dedicated line, or the like.

The image processing program 2 is stored in the storage unit 30. A software management area 3 is secured in the storage unit 30. The software management area 3 is an area used by the image processing program 2. An original image area 51 and a processed file area 52 are secured in the software management area 3. The roles of these areas 51 and 52 will be described later.

The control unit 40 operates in a virtual manner as a display control unit 41, an image processing unit 42, an export unit 43, a print control unit 44, a selection unit 45, a registration unit 46, a re-selection unit 47, and an edit unit 48, by reading out and executing the image processing program 2 stored in the storage unit 30. The operations of the units 41 to 48 will be described later.

2. Detailed Description of Configuration and Operations of Image Processing Apparatus

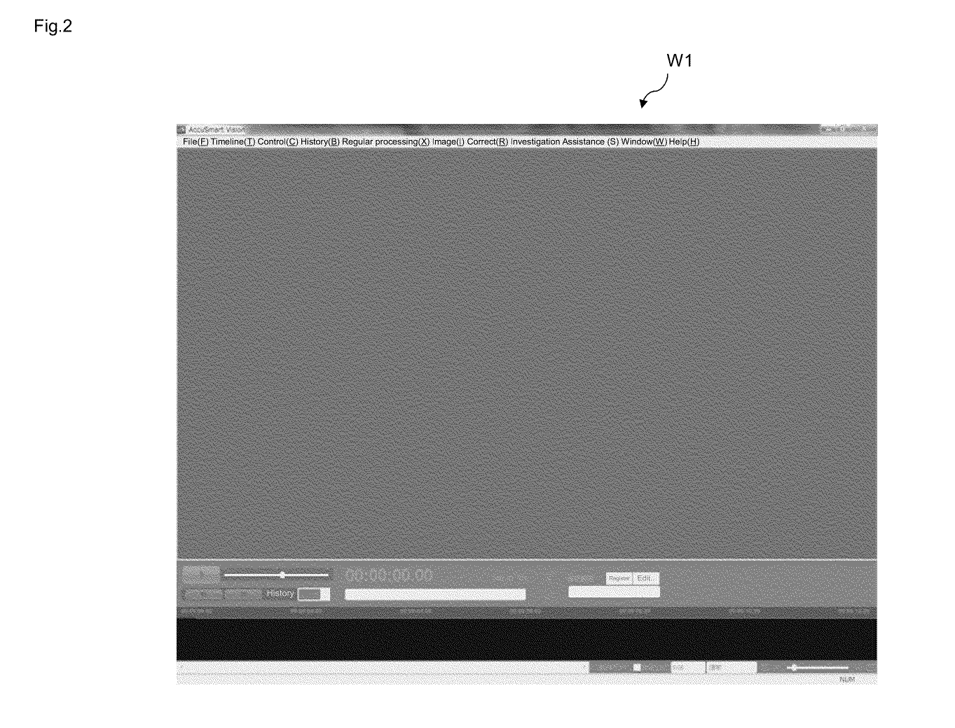

The control unit 40 starts the image processing program 2 upon detecting that the user has performed a predetermined operation via the input unit 20. When the image processing program 2 has been started, a basic screen W1 (see FIG. 2) is displayed on the display 10. Note that the display control unit 41 controls the display of screens, windows, buttons and all other elements that are displayed on the display 10.

2-1. Import of Image Data

The basic screen W1 receives an instruction to import image data to the original image area 51 from a user. Image data imported to the original image area 51 is targeted for later-described playback processing, image processing, export processing and print processing. The control unit 40 imports image data to the original image area 51 from a still image file or a moving image file. Note that in this specification, still image files are data files in a still image format, and moving image files are data files in a moving image format.

In the case of importing image data from a still image file, the user designates one still image file or one folder by operating the input unit 20. In the case of the former, the control unit 40 prompts the user to input a filename and an address path in the storage unit 30 for that still image file. In the case of the latter, the control unit 40 prompts the user to input a folder name and an address path in the storage unit 30 for that folder. Thereafter, the control unit 40 saves the designated still image file or all the still image files in the designated folder as a still image file group in the original image area 51. Note that the term “group” used in this specification is not limited to being made up of multiple elements, and may be made up of one element.

On the other hand, in the case of importing image data from a moving image file, the user inputs a filename and an address path in the storage unit 30 for one moving image file by operating the input unit 20. The display control unit 41 displays a moving image import window (not shown) in a superimposed manner on the basic screen W1 upon detecting that the user designated a moving image file. The moving image import window receives the selection of a segment of arbitrary length from the user, out of the entire segment of the timeline of the designated moving image file. Upon detecting that the user selected a specific segment via the input unit 20, the control unit 40 generates a still image file group that corresponds on a one-to-one basis to the group of frames included in the specific segment of the designated moving image file. Thereafter, the control unit 40 saves this still image file group in the original image area 51. Accordingly, in the present embodiment, the image data targeted for later-described playback processing, image processing, export processing and print processing is not a moving image file, but rather still image files.

Note that even if a still image file group imported to the original image area 51 originates from still image files rather than from a moving image file, the control unit 40 recognizes the still image file group as being a group of still image files that are included in a moving image and are arranged in a timeline. The arrangement is automatically determined based on file attributes (filename, created on date/time, updated on date/time, or the like).

2-2. Playback Processing

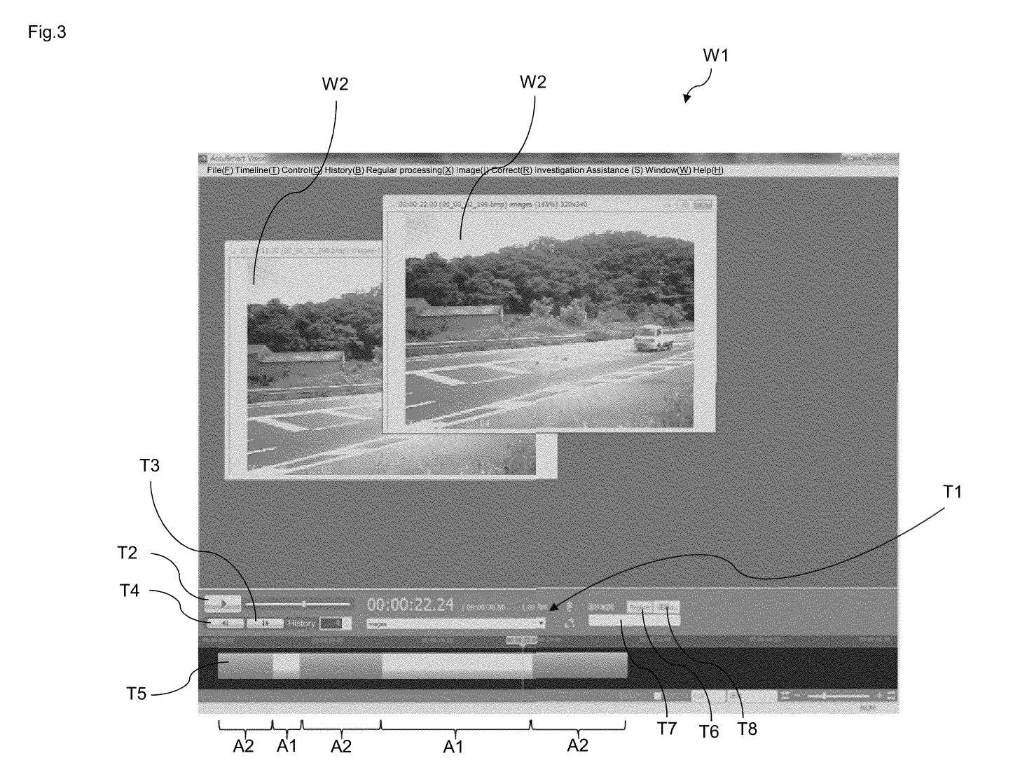

When a still image file group is imported to the original image area 51, the display control unit 41 displays a display window W2 (see FIG. 3) in a superimposed manner on the basic screen W1. The number of display windows W2 that are created is the same as the number of timelines of the still image file groups that were imported to the original image area 51.

First, one still image file included in the still image file group imported to the original image area 51 (e.g., the still image file corresponding to the first frame on the timeline) is displayed in the display window W2. Thereafter, the frame that is displayed in the display window W2 is switched based upon a user operation, as will be described later.

As shown in FIG. 3, a window selection pull-down menu T1, a play button T2, a frame advance button T3, a frame reverse button T4, a timeline bar T5, a register button T6, a segment selection pull-down menu T7 and an edit button T8 are arranged on the basic screen W1.

Even if there are multiple display windows W2, there is only one active display window W2. The window selection pull-down menu T1 receives a user selection of which display window W2 is to be made active. Hereinafter, the timeline that corresponds to the active display window W2 is referred to as the active timeline, and frame group that belongs to the active timeline is referred to as the active frame group. Also, the frame currently displayed in the active display window W2 is referred to as the active display frame.

The active frame group can be played back as a moving image in the active display window W2 by the display control unit 41. The play button T2 receives a user instruction to play back the active frame group as a moving image. Upon detecting that the user has pressed the play button T2 via the input unit 20, the display control unit 41 displays the frames included in the active frame group sequentially along the timeline in the active display window W2 in a frame advance format. Note that playback starts from the active display frame at the point in time when the play button T2 is pressed. Also, the play button T2 receives a user instruction to stop playback. Upon detecting that the user has pressed the play button T2 via the input unit 20 during playback, the display control unit 41 fixes the display in the active display window W2 to the active display frame at that point in time.

The frame advance button T3 and the frame reverse button T4 respectively receive user instructions to switch the active display frame to the next frame and the previous frame along the active timeline.

The timeline bar T5 is an object that diagrammatically represents the active timeline. The timeline bar T5 is equally divided in the direction in which the bar extends, the number of the divided areas being the same as the number of frames included in the active frame group. An n-th divided area from the left on the timeline bar T5 corresponds to the n-th frame on the active timeline (where n is a natural number).

The selection unit 45 receives a user selection of an arbitrary segment on the active timeline via the timeline bar T5. The segment to be selected may be a continuous section, or may be a discontinuous section as shown in FIG. 3. In other words, the user can select any number of any frames from the active frame group by operating (for example, clicking) divided areas on the timeline bar T5 through the input unit 20. Accordingly, it is possible to select a plurality of divided areas at the same time.

As shown in FIG. 3, divided areas A1 corresponding to a selected frame group and divided areas A2 corresponding to a non-selected frame group are displayed in a different manner in the timeline bar T5. The selected frame group is the frame group belonging to the segment that is currently selected on the active timeline by the user. The non-selected frame group is the frame group belonging to the segment that is not currently selected on the active timeline by the user.

The image processing unit 42 recognizes the selected frame group as being the target of later-described image processing. Also, the export unit 43 and the print control unit 44 recognize the selected frame group respectively as being the targets of later-described export processing and print processing. Note that each time a divided area on the timeline bar T5 is selected by the user, the active display frame is switched to the frame that corresponds to the most recently selected divided area.

The registration unit 46 receives from the user an instruction to register the segment corresponding to the selected frame group via the register button T6. Upon detecting that the user has pressed the register button T6 via the input unit 20, the registration unit 46 stores information that specifies the segment corresponding to the selected frame group at that time (registration target segment) in the segment database (hereinafter referred to as the “segment DB”) 53 (registration processing). Note that the segment that is registered here is a unit of segment selection on the active timeline performed by the user via a later-described segment selection pull-down menu T7.

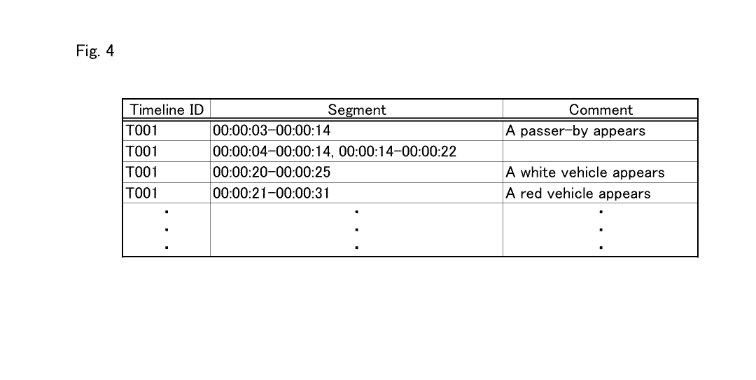

Here, the segment DB 53 is defined in the software management area 3 as shown in FIG. 1. Also, as shown in FIG. 4, the segment DB 53 has a timeline ID field, a segment field, and a comment field. The timeline ID field is a field for storing an ID for identifying the timeline (hereinafter referred to as a “timeline ID”), the segment field is a field for storing information that specifies a segment on the timeline, and the comment field is a field for storing a comment regarding the segment.

Each time the above registration processing is executed, one new record is created in the segment DB 53. The record holds the timeline ID of the active timeline at the time when the register button T6 was pressed in the timeline ID field, and holds information that specifies the registration target segment in the segment field. Note that the comment is set using edit processing, which will be described later. Accordingly, immediately after the registration processing is executed, the value in the comment field of the record created using the registration processing is “NULL”. The registration processing above can be executed any number of times at various timings. That is to say, the user can register multiple segments at the same time in the segment DB 53.

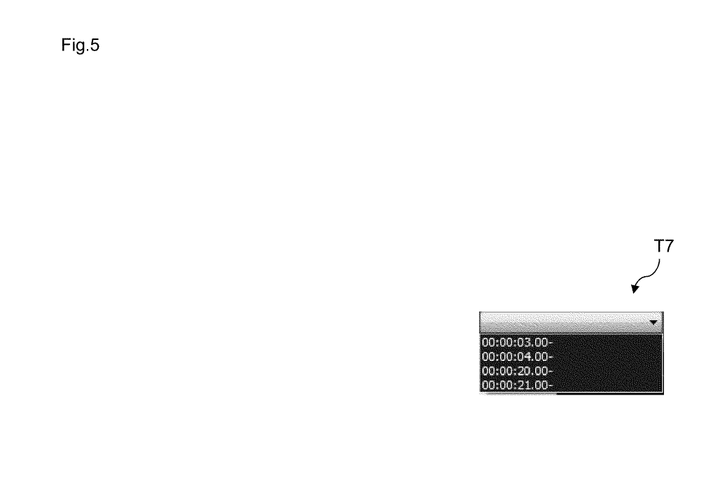

The re-selection unit 47 receives from the user a selection of any one segment out of one or more segments registered in the segment DB 53 via the segment selection pull-down menu T7. That is to say, the one or more segments that are registered in the segment DB 53 are the options in the selection of a segment via the segment selection pull-down menu T7. FIG. 5 shows a state in which the segment selection pull-down menu T7 is opened, and in this example, it is clear that there are four items in the segment selection pull-down menu T7 and four segments are currently registered. Upon detecting that the user has selected one item from the segment selection pull-down menu T7 via the input unit 20, the re-selection unit 47 releases the selected frame group at that time and selects the frame group belonging to the segment corresponding to the selected item as the new selected frame group (re-selection processing).

The edit unit 48 receives from the user an instruction to start edit processing for performing editing of a segment registered in the segment DB 53, via the edit button T8. The edit processing is processing for deleting any segment, joining any two or more segments together, or setting a comment in any segment among the segments registered in the segment DB 53.

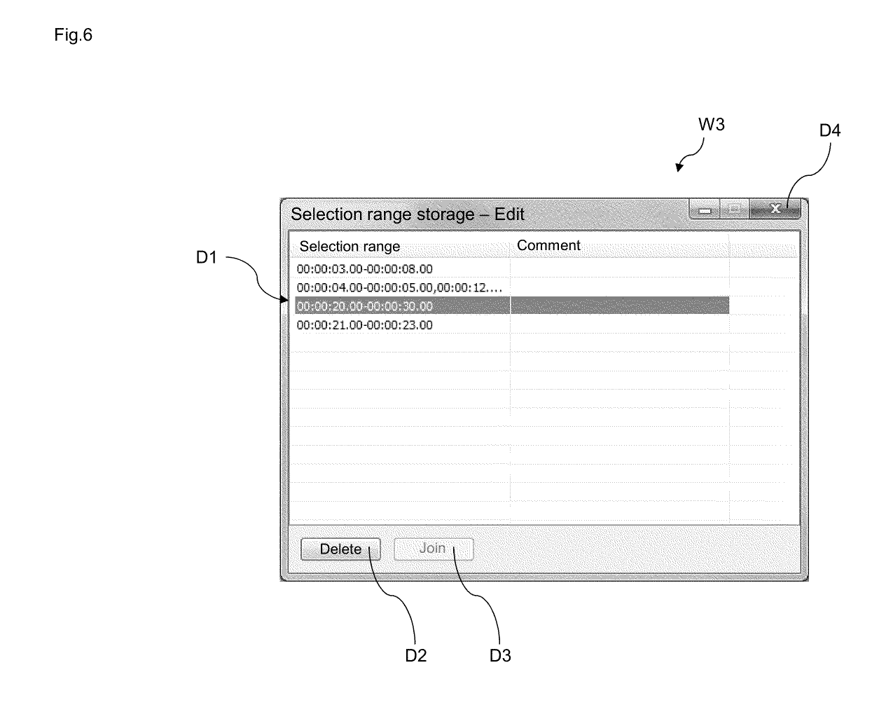

Specifically, when the edit unit 48 detects that the user has pressed the edit button T8, the display control unit 41 causes the edit window W3 (see FIGS. 6 to 8) to be displayed in an overlapping manner on the basic screen W1. A table D1, a delete button D2, and a join button D3 are arranged in the edit window W3.

The rows included in the table D1 have a one-to-one correspondence with the records stored in the segment DB 53, or in other words, with the segments registered in the segment DB 53. Each row has a “selection range” column that displays information for specifying the corresponding segment, and a “comment” column that displays a comment regarding the corresponding segment. The content displayed in the respective columns matches the values stored in the segment field and the comment field in the segment DB 53. Note that as will be described later, the values in the segment DB 53 can be changed using edit processing, and the change will be reflected in the mode of displaying the table D1 in real time. That is to say, the values in the segment DB 53 and mode of displaying the table D1 are linked in real time.

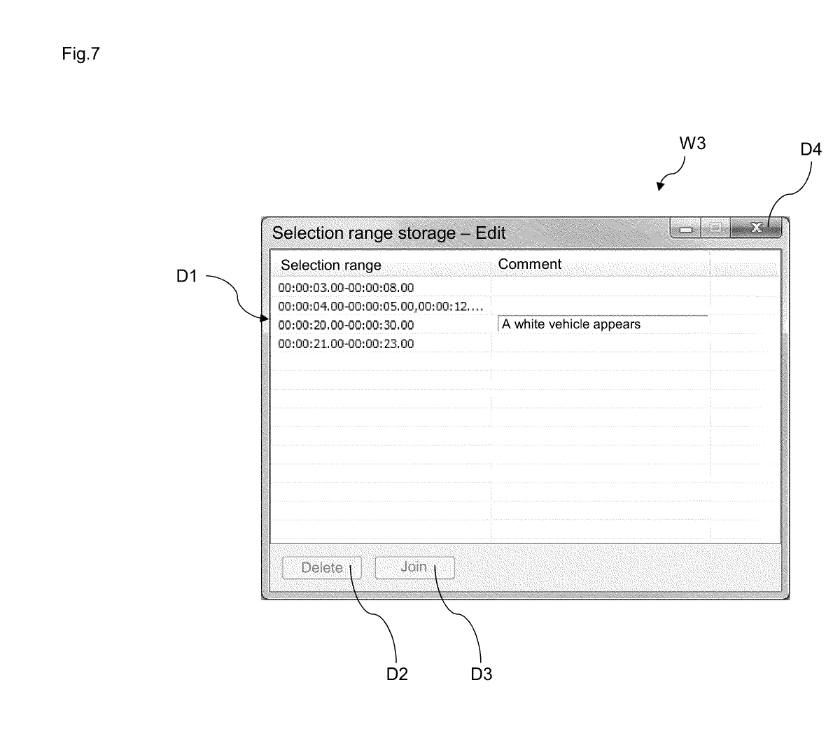

The edit unit 48 receives from the user the input of a character string (may be one character) in the “comment” column for the rows in the table D1 using a free description format. This function enables the user to freely set descriptions for the segments as appropriate so that it is easy to remember later what kind of segments they are. For example, if the segment to which the user is attempting to give a comment corresponds to a frame group in which a white vehicle appears, the user can input a comment such as “A white vehicle appears” (see FIG. 7).

Upon detecting that the user has input a comment in the “comment” column of a specific row, the edit unit 48 stores the character string of the comment in the comment field of the record corresponding to that row in the segment DB 53. Also, the edit unit 48 receives a user operation for changing the comment in the “comment” column. Upon detecting the change operation, the edit unit 48 causes the content of the change to be reflected in the value in the segment DB 53. Accordingly, processing for inputting/changing a comment corresponding to the specific row is processing for storing the input/changed comment in association with the segment corresponding to that row.

Also, the edit unit 48 receives a user operation for selecting any number of any rows out of the rows included in the table D1. If one or more rows have been selected in the table D1, upon detecting that the user has pressed the “delete” button D2 via the input unit 20, the edit unit 48 executes deletion processing for deleting the registration of the segment (referred to below as the “selected segment”) corresponding to the row that has been selected at that time (referred to below as the “selected row”). Specifically, the edit unit 48 deletes the record corresponding to the selected row at the time when the “delete” button D2 was pressed from the segment DB 53. Note that if no row has been selected in the table D1, the “delete” button D2 is disabled and the deletion instruction cannot be received (see FIG. 7).

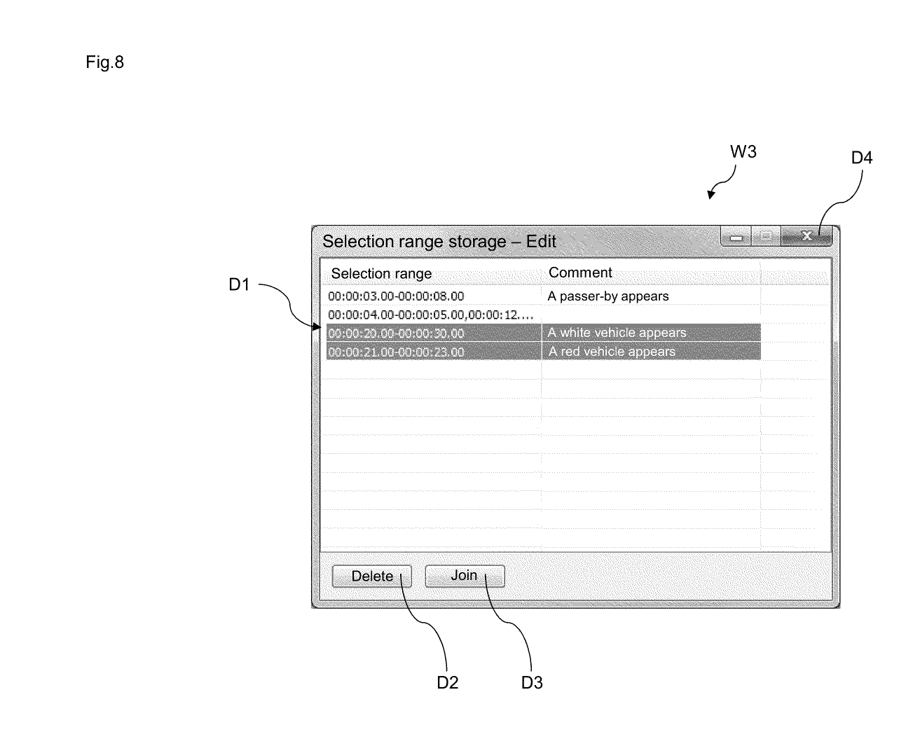

Also, the edit unit 48 receives from the user an instruction to join multiple selected segments together via the “join” button D3. If multiple rows have been selected in the table D1 (see FIG. 8), upon detecting that the user has pressed the “join” button D3 via the input unit 20, the edit unit 48 executes joining processing for joining together the selected segments at that time. Specifically, the edit unit 48 derives information specifying a joined segment in which the multiple selected segments at the time when the “join” button D3 is pressed have been joined together without overlapping. Then, the edit unit 48 creates one new record, which holds the timeline ID of the active timeline at the time when the “join” button D3 is pressed in the timeline ID field and holds the information for specifying the joined segment in the segment DB 53, and stores the record in the segment DB 53. At this time, in the present embodiment, the records corresponding to the selected rows at the time when the “join” button D3 was pressed are deleted from the segment DB 53. However, in other embodiments, it is possible to keep them, and it is possible to allow the user to set in advance whether to keep or delete them, or to allow the user to select them every time. Note that if one row or less has been selected in the table D1, the “join” button D3 is disabled, and the join instruction cannot be received (see FIGS. 6 and 7).

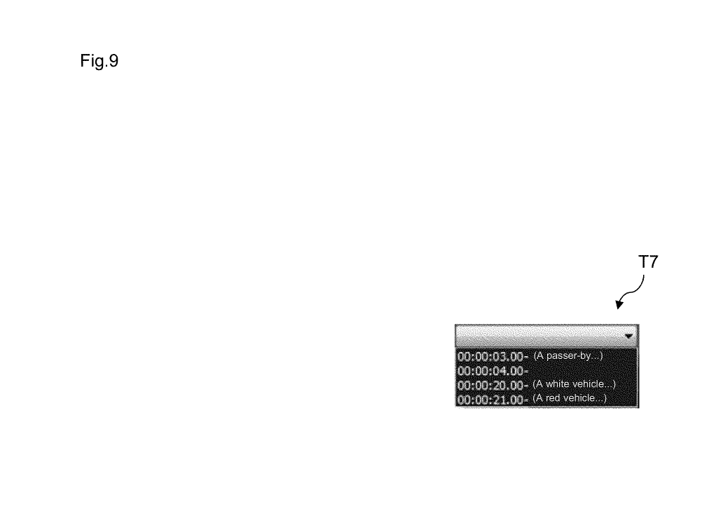

The above edit processing ends when the edit unit 48 detects that the user has pressed the “X” button D4 in the edit window W3. FIG. 9 shows the segment selection pull-down menu T7 immediately after the edit processing that started from the state shown in FIG. 5 has ended in the state shown in FIG. 8. Here, the display control unit 41 creates the segment selection pull-down menu T7 by referencing the segment DB 53. Accordingly, as can be understood by comparing FIGS. 5 and 9, the comment (if it is long, only the beginning part) that was set using the edit processing is displayed as part of the item name in the segment selection pull-down menu T7. More precisely, as shown in FIG. 9, the items in the segment selection pull-down menu T7 are pieces of information for displaying the information that specifies a segment registered in the segment DB 53 (if it is long, only the beginning part) and the comment corresponding to that segment (if it is long, only the beginning part) in association with each other. As a result, when a specific segment is to be selected out of the segments registered in the segment DB 53, the user can reference these pieces of information and can easily decide whether or not to re-select a registered segment while giving particular consideration to the comments set by the user. Note that in the present embodiment, the information for specifying a segment and the comment corresponding to that segment registered in the segment DB 53 are displayed next to each other in the segment selection pull-down menu T7. However, if the latter information has been set, the latter information may be displayed in place of the former information in the segment selection pull-down menu T7, and it is possible to display only the former information even if the latter information has been set.

2-3. Image Processing

Hereinafter, image processing by the image processing unit 42 will be described. The target of image processing is the selected frame group that is selected via the timeline bar T5 or the segment selection pull-down menu T7. The image processing unit 42 can execute multiple image processing modules such as noise removal, sharpness, brightness/contrast/chroma adjustment, image resolution adjustment, rotation, and the addition of characters/arrows/mosaic, image averaging, and position adjustment. The image processing modules are incorporated in the image processing program 2.

By operating the basic screen W1 via the input unit 20, the user can select any of the image processing modules any number of times in any order among the above-mentioned various image processing modules. Each time the image processing unit 42 detects that the user selected an image processing module, it executes that image processing module on the selected frame group at that point in time. That is, selecting the image processing module by a user means that he or she instructs to execute that image processing module. Note that the execution of an image processing module on a selected frame group refers to the execution of that image processing module on each frame included in that selected frame group.

As image processing modules are executed on a frame sequentially, that is, once, twice, thrice, and so on, that frame is sequentially manipulated into a first-order frame, a second-order frame, a third-order frame, and so on. A 0-th-order frame corresponds to a still image file saved in the original image area 51. An (m+1)-th-order frame corresponds to a still image file obtained after an image processing module has been executed once on a still image file corresponding to an m-th-order frame (where m is an integer greater than or equal to 0). The image processing unit 42 sequentially generates still image files that correspond to the first-order and subsequent frames, and saves those still image files individually in the processed file area 52.

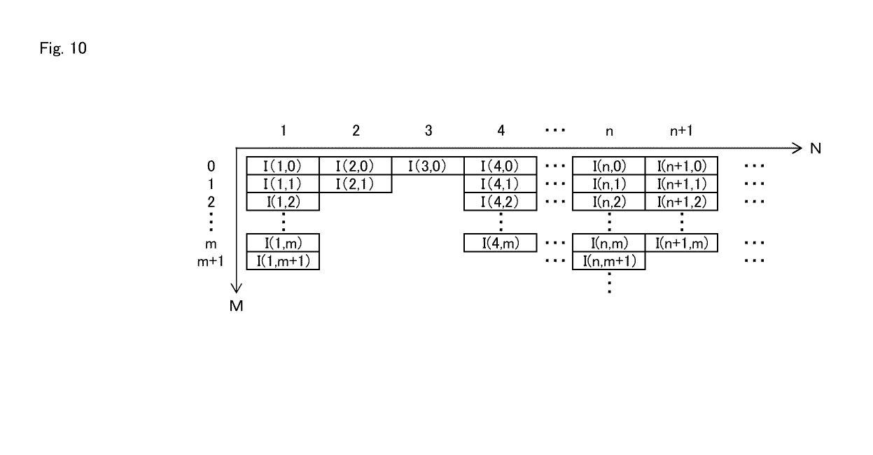

FIG. 10 is a conceptual diagram showing how a group of still images belonging to one timeline is managed by the image processing program 2. In FIG. 10, an N axis, which is the horizontal axis, represents the order of the frames on the timeline, and an M axis, which is the vertical axis, represents the order of processing. The box corresponding to the coordinates (n,m) in an N-M space in FIG. 10 represents the still image I (n,m). The still image I (n,m) is the m-order still image of the n-th frame on the timeline (where n is a natural number, and m is an integer greater than or equal to 0).

For each frame, the control unit 40 manages the value of the currently selected coordinate m as a parameter mₛ. Immediately after a group of still image files has been imported to the original image area 51, the coordinate mₛ takes an initial value 0. Thereafter, every time the image processing module is executed, the coordinate mₛ of the frame is incremented by 1. Also, the user is able to freely change the coordinate mₛ of the selected frame group by performing a predetermined operation via the input unit 20. Note that executing an image processing module on a frame refers to executing the image processing module on an mₛ-order still image of the frame. Accordingly, changing the coordinate mₛ effectively means changing the execution target of the image processing module. Incidentally, displaying a frame refers to displaying a still image of the coordinate mₛ of the frame. Accordingly, changing the coordinate mₛ also effectively means changing the target to be displayed on the active display window W2.

2-4. Export Processing

Export processing performed by the export unit 43 will be described below. Here, the selected frame group that is selected via the timeline bar T5 or the segment selection pull-down menu T7 is the target of export processing. Export processing is processing by which the still images having the coordinate mₛ of all frames that are managed in the software management area 3 by the image processing program 2 and are included in the selected frame group are exported from the software management area 3. Export modes include a mode of exporting the still images as a still image file group, a mode of exporting them as a video file, and a mode of creating a material file that includes the still images.

The user can instruct the export unit 43 to execute export processing by performing an operation on the basic screen W1 via the input unit 20. At this time, the export unit 43 allows the user to designate the export mode and the directory address path in the storage unit 30 that is to store the exported output file. The export unit 43 detects the operations performed by the user, creates an output file by processing the still images having the coordinate mₛ of all frames included in the selected frame group at that time using the mode designated by the user, and stores the output file in the directory that was designated by the user.

Specifically, if the still image file group has been designated as the export mode, the export unit 43 sequentially outputs the still images having the coordinate mₛ of all frames included in the selected frame group using a still image file format. The output files are automatically given file names by which the order n on the timeline of the original frame is understood. Accordingly, the user or another piece of application software that loads these files can know the arrangement of the output files on the timeline.

On the other hand, if a video file has been designated as the output mode, the export unit 43 creates a video file by successively incorporating the still images having the coordinate mₛ of all frames included in the selected frame group in accordance with the order n on the timeline.

Also, if material creation has been designated as the export mode, the export unit 43 creates a material file incorporating the still images having the coordinate mₛ of all frames included in the selected frame group. The material file is created using a file format that can be opened by another piece of application software, for example, a document file format. Note that information other than the still images corresponding to the selected frame group is included as necessary in the material file. This information may be determined in advance according to the purpose or the like of the material, and the user may be allowed to input this info as necessary when the export processing is executed.

2-5. Print Processing

Print processing performed by the print control unit 44 will be described below. Here, the selected frame group that is selected via the timeline bar T5 or the segment selection pull-down menu T7 is the target of print processing. Print processing is processing for the printer connected to the image processing apparatus 1 via the communication unit 50 to print the still images having the coordinate mₛ of all frames included in the selected frame group. Specifically, upon detecting that the user has instructed the execution of print processing via the input unit 20, the print control unit 44 provides the data for the still images of the coordinate mₛ of all frames included in the selected frame group at that time to the printer via the communication unit 50. As a result, the still images are output on a paper medium from the printer.

Note that the frame group that is the target of executing the print processing is not limited to the selected frame group. By allowing the user to designate all frames or any other segment on the active timeline for example at the time of executing print processing, the print control unit 44 can execute similar print processing for that kind of frame group.

3. Application

The image processing program 2 can handle image processing with respect to various types of video, and for example, it can be used in the field of analyzing surveillance video from a security camera in order for an organization such as the police to investigate an incident. For example, a case is conceivable in which a suspect is captured in a video captured by a security camera. At this time, an observer first plays back the video or the like and finds some segments in which the suspect appears in the video, and it is very likely that the notable segments will be later referenced many times. That is to say that out of all of the segments in the video, image processing, export processing, or print processing is likely to be performed with a focus on the frame groups belonging to the segments in which the suspect appears. However, if it is not clear where the previously-found noteworthy segments are, the observer will need to find them again. Also, even if the observer remembers the notable segments, he or she will be greatly burdened if those segments need to be selected every time using the same operation that was used previously. The registration processing, and the subsequent re-selection processing and edit processing according to the present embodiment can be said to be particularly useful in such a situation. That is to say that when the observer first finds a noteworthy segment, if he or she thinks that the same segment is very likely to be re-selected, he or she can later re-select that same segment with a simple operation by registering the segment in advance.

4. Features

In the above-described embodiment, the user can select any segment on the timeline of a video via the timeline bar T5 as the target of image processing, export processing, or print processing. Also, the currently-selected segment on the timeline is not only the target of image processing and the like, but it can also be registered in the segment DB 53 upon the reception of a user operation of pressing the register button T6. Then, the segment registered in this way can thereafter be easily re-selected by the user as the target of image processing and the like via the segment selection pull-down menu T7. Thus, the user need only register segments that are likely to be re-selected in advance in the segment DB 53. As a result, it is not necessary for the user to remember which frames were selected, and even if many frames are selected, the number of operations will not increase excessively.

5. Variations

Although an embodiment of the present invention has been described above, the present invention is not limited to the above-described embodiment, and various modifications are possible within a scope that does not deviate from the gist of the invention. For example, the following modifications are possible.

5-1

In the above embodiment, a free description format comment is set for a registered segment using edit processing, but it is possible to enable attribute information in another format to be set in place of or in addition to this. For example, it is possible to enable the setting of attribute information selected out of predetermined options by providing a checkbox for “important” or the like. Also, in the above embodiment, the attribute information is received after the segments have been registered, but, in place of or in addition to this, it is possible to enable setting with respect to the segments that are being registered at the time of registering the segments.

5-2

An upper limit may be provided for the number of segments that can be registered, and needless to say, that number may be one.

5-3

In the above-described embodiment, the segment corresponding to the selected frame group at the time when the registration instruction was input is the target of registration. However, the registration target may be a segment selected by the user in a predetermined period after the registration instruction has been input. In that case, an operation for determining the timing of the end of the predetermined period may be received from the user.

5-4

In the above-described embodiment, the target of image processing, export processing, or print processing is the selected frame group at the time when the execution of image processing or the like was instructed. However, the target of image processing or the like may be a segment selected by the user in a predetermined period after the execution instruction for image processing or the like has been input. In that case, an operation for determining the timing of the end of the predetermined period may be received from the user.

5-5

In the above-described embodiment, a method of allowing the user to perform operations on the timeline bar T5 is employed as a method for allowing the user to select any segment on the active timeline. However, various methods can be employed as long as they enable the user to specify any segment, such as allowing the user to manually input times corresponding to the beginning and end of the segment.

5-6

In the above-described embodiment, it is possible to specify not only a continuous segment, but also non-continuous segments via the timeline bar T5. However, it is also possible to enable only the selection of any continuous segments.

1. An image processing apparatus comprising:
a selection unit configured to allow a user to select any segment on a timeline of a video;
a registration unit configured to receive a registration instruction from the user and execute registration processing for registering the segment that is currently selected on the timeline;
a re-selection unit configured to allow the user to select the registered segment; and
a frame processing unit configured to execute image processing, export processing, or print processing on a frame group belonging to the segment that is currently selected on the timeline.

2. The image processing apparatus according to claim 1,
wherein the re-selection unit is configured to allow the user to select any segment among options including a plurality of segments that have been registered using registration processing that was executed at different times.

3. The image processing apparatus according to claim 1, further comprising:
an edit unit configured to receive, from the user, an instruction to join together a plurality of segments that have been registered using registration processing that was executed at different times, and execute joining processing for registering a segment obtained by joining together the plurality of segments.

4. The image processing apparatus according to claim 2, further comprising:
an edit unit configured to receive, from the user, an instruction to join together a plurality of segments that have been registered using registration processing that was executed at different times, and execute joining processing for registering a segment obtained by joining together the plurality of segments.

5. The image processing apparatus according to claim 1, further comprising:
an edit unit configured to allow the user to input attribute information corresponding to a segment that has been registered or is being registered using the registration processing, and store the attribute information in association with the segment; and
a display control unit configured to display the attribute information that was stored in association with the segment, in association with the segment such that the user can reference the attribute information when selecting the registered segment.

6. The image processing apparatus according to claim 2, further comprising:
an edit unit configured to allow the user to input attribute information corresponding to a segment that has been registered or is being registered using the registration processing, and store the attribute information in association with the segment; and
a display control unit configured to display the attribute information that was stored in association with the segment, in association with the segment such that the user can reference the attribute information when selecting the registered segment.

7. The image processing apparatus according to claim 5,
wherein the edit unit is configured to allow the user to input the attribute information in a free description format.

8. The image processing apparatus according to claim 6,
wherein the edit unit is configured to allow the user to input the attribute information in a free description format.

9. A non-transitory computer-readable medium storing an image processing program for causing a computer to execute steps of:
allowing a user to select any segment on a timeline of a video;
receiving a registration instruction from the user and executing registration processing for registering the segment that is currently selected on the timeline;
allowing the user to select the registered segment; and
executing image processing, export processing, or print processing on a frame group belonging to the segment that is currently selected on the timeline.

10. The non-transitory computer-readable medium according to claim 9,
wherein the allowing the user to select the registered segment includes allowing the user to select any segment among options including a plurality of segments that have been registered using registration processing that was executed at different times.

11. The non-transitory computer-readable medium according to claim 9, the program causing the computer to further execute a step of:
receiving, from the user, an instruction to join together a plurality of segments that have been registered using registration processing that was executed at different times, and executing joining processing for registering a segment obtained by joining together the plurality of segments.

12. The non-transitory computer-readable medium according to claim 10, the program causing the computer to further execute a step of:
receiving, from the user, an instruction to join together a plurality of segments that have been registered using registration processing that was executed at different times, and executing joining processing for registering a segment obtained by joining together the plurality of segments.

13. The non-transitory computer-readable medium according to claim 9, the program causing the computer to further execute steps of:
allowing the user to input attribute information corresponding to a segment that has been registered or is being registered using the registration processing, and storing the attribute information in association with the segment; and
displaying the attribute information that was stored in association with the segment, in association with the segment such that the user can reference the attribute information when selecting the registered segment.

14. The non-transitory computer-readable medium according to claim 10, the program causing the computer to further execute steps of:
allowing the user to input attribute information corresponding to a segment that has been registered or is being registered using the registration processing, and storing the attribute information in association with the segment; and
displaying the attribute information that was stored in association with the segment, in association with the segment such that the user can reference the attribute information when selecting the registered segment.

15. The non-transitory computer-readable medium according to claim 11, the program causing the computer to further execute steps of:
allowing the user to input attribute information corresponding to a segment that has been registered or is being registered using the registration processing, and storing the attribute information in association with the segment; and
displaying the attribute information that was stored in association with the segment, in association with the segment such that the user can reference the attribute information when selecting the registered segment.

16. The non-transitory computer-readable medium according to claim 12, the program causing the computer to further execute steps of:
allowing the user to input attribute information corresponding to a segment that has been registered or is being registered using the registration processing, and storing the attribute information in association with the segment; and
displaying the attribute information that was stored in association with the segment, in association with the segment such that the user can reference the attribute information when selecting the registered segment.

17. The non-transitory computer-readable medium according to claim 13,
wherein the edit unit is configured to allow the user to input the attribute information in a free description format.

18. The non-transitory computer-readable medium according to claim 14,
wherein the edit unit is configured to allow the user to input the attribute information in a free description format.

19. The non-transitory computer-readable medium according to claim 15,
wherein the edit unit is configured to allow the user to input the attribute information in a free description format.

20. The non-transitory computer-readable medium according to claim 16,
wherein the edit unit is configured to allow the user to input the attribute information in a free description format.
